(19) United States
(12) Patent Application Publication
(10) Pub. No.: US 2025/0287431 A1
(43) Pub. Date: Sep. 11, 2025

(54) COMMUNICATION SYSTEMS, APPARATUSES, METHODS, AND NON-TRANSITORY COMPUTER-READABLE STORAGE DEVICES FOR WIRELESS COMMUNICATION USING A HIGHLY OVERLAPPING BEAM-LAYOUT

(71) Applicant: Huawei Technologies Co., Ltd., Shenzhen (CN)

(72) Inventors: Jalal Khamse Ashari, Stittsville (CA); Amine Maaref, Ottawa (CA)

(21) Appl. No.: 19/092,925

(22) Filed: Mar. 27, 2025

Related U.S. Application Data
(63) Continuation of application No. PCT/CN2023/071448, filed on Jan. 9, 2023.

(51) Int. Cl. H04W 74/0833; H04W 72/542

(52) U.S. Cl. CPC H04W 74/0833; H04W 72/542

(57) ABSTRACT

A communication system, a radio access network (RAN), a user equipment (UE), and/or one or more non-transitory computer-readable storage devices are configured for performing a method leveraging a highly overlapping beam layout for communication between the RAN and UE. The method may include: receiving a plurality of synchronization signal blocks (SSBs) of a plurality of beams of a plurality of different beam layers, each SSB associated with a respective beam, and each beam associated with a respective beam layer; determining reference-signal received powers (RSRPs) of the SSBs; and selecting one or more of the SSBs based on the measured RSRPs for performing an initial-access procedure to a serving cell. Based on the received position information, the RAN may transmit a narrow-width beam towards the UE for performing an initial-access procedure to a serving cell.

### CROSS-REFERENCE TO RELATED APPLICATION

This application is a continuation of PCT Application No. PCT/CN2023/071448, entitled “COMMUNICATION SYSTEMS, APPARATUSES, METHODS, AND NON-TRANSITORY COMPUTER-READABLE STORAGE DEVICES FOR WIRELESS COMMUNICATION USING A HIGHLY OVERLAPPING BEAM-LAYOUT,” filed on Jan. 9, 2023, which application is hereby incorporated herein by reference in its entirety.

### TECHNICAL FIELD

The present disclosure relates generally to communication systems, apparatuses, methods, and non-transitory computer-readable storage devices, and in particular to communication systems, apparatuses, methods, and non-transitory computer-readable storage devices for wireless communication using a highly overlapping beam-layout.

### REFERENCE TO ACRONYM KEY AND DEFINITIONS OF SOME TECHNICAL TERMS

For ease of reading, subsections C and D of the Detailed Description, respectively, list the acronyms and definitions of some technical terms used in this disclosure.

### BACKGROUND

Mobile communication systems are known. While most mobile communication systems are so-called terrestrial network (TN) systems (which generally comprise a plurality of transmit-receive points (TRPs) deployed on the ground), non-terrestrial network (NTN) systems (which generally comprise a plurality of non-terrestrial TRPs such as satellites and high altitude platform stations (HAPS) deployed above ground or in the space) are also deployed or started their deployment in recent years.

In NTN systems, the non-terrestrial TRPs transmit a plurality of signal beams towards the ground to form a plurality of service cells. In conventional NTNs, the signal beams are usually deployed in a regular beam-layout pattern (see FIG. 1) such as a grid of rectangular/hexagonal beams/cells, wherein the same beam shape is repeated over the entire coverage area. However, using such a regular/uniform beam-layout pattern for both reference signal (such as the synchronization signal and physical broadcast channel (PBCH) block (SSB)) and data transmission may not meet the spatiotemporal variations in user traffic demands. Moreover, the conventional beam layout may result in a low availability and/or throughput, especially at the cell/beam-edge regions. More specifically, because of the variations of the reference-signal received power (RSRP) across the beam coverage, the RSRP may be weak or otherwise vanishing around the beam edge. Hence, to avoid coverage holes and to enhance the availability, one may need to allow partial overlaps between the adjacent beams (see FIG. 1), which, however, may result in the inter-beam interference and consequently inefficient utilization of the resources (such as the number of antennas and radio-frequency (RF) chains, processing power, and/or the like). Moreover, the capacity for a non-terrestrial TRP is usually limited by the number of deployed beams. Thus, it is necessary to deploy the beams in an efficient manner in order to efficiently utilize such limited resources.

### SUMMARY

Embodiments of this disclosure relate to communication systems, apparatuses, methods, and non-transitory computer-readable storage devices for wireless communication using a highly overlapping beam-layout.

According to one aspect of this disclosure, there is provided a first method comprising: receiving a plurality of synchronization signal and physical broadcast channel (PBCH) blocks (SSBs) of a plurality of beams of a plurality of different beam layers, each SSB associated with a respective beam, and each beam associated with a respective beam layer; determining reference-signal received powers (RSRPs) of the SSBs; and selecting one or more of the SSBs based on the RSRPs for performing an initial-access procedure to a serving cell.

With the above method, a user equipment (UE) may always leverage one or more SSBs of sufficiently high RSRPs for performing an initial-access procedure to a serving cell, thereby solving the above-mentioned cell/beam-edge issues, avoiding inter-beam interference and consequently efficient utilizing the resources.

In some embodiments, said receiving the SSBs comprises: determining the association of the SSBs and the beam layers based on one or more characteristics of the SSBs, thereby allowing easy and/or flexible identification of different beam layers.

In some embodiments, the one or more characteristics of the SSBs are one or more of one or more characteristics of a frequency domain, one or more characteristics of a time domain, one or more characteristics of a code domain, one or more characteristics of a space domain, and content of the SSBs.

In some embodiments, the content of the SSBs comprises identifiers (IDs) of the beam layers.

In some embodiments, said selecting the one or more of the SSBs based on the RSRPs comprises: selecting one SSB associated with a first beam layer that has the greatest RSRP among the received SSBs associated with the first beam layer; or selecting one or more of the SSBs associated with a first beam layer whose RSRPs are greater than a first RSRP threshold. Thus, a UE may leverage one or more “strong” SSBs (that is, SSBs of sufficiently high RSRPs) for performing an initial-access procedure to a serving cell, thereby improving the performance of the UE.

In some embodiments, the first method further comprises: determining and reporting position information based on the SSBs and the RSRPs thereof. Such position information may be used to facilitate a more “focused” initial-access procedure with improved performance. For example, a radio access network (RAN) may transmit a narrow beam to the UE based on the determined position information for performing the initial-access procedure without the above-mentioned cell/beam-edge issues, avoiding inter-beam interference and consequently efficient utilizing the resources.

In some embodiments, said determining and reporting the position information comprises: reporting IDs of the selected one or more beam layers.

In some embodiments, said determining and reporting the position information comprises: determining relative distances to the plurality of beams based on the RSRPs thereof; determining a relative position with respect to the plurality of beam layers using triangulation based on the determined relative distances; and reporting the determined relative position and/or the relative distances.

In some embodiments, said determining and reporting the position information comprises: determining a zone based on the RSRPs; and reporting the determined zone. The use of zones may simplify the determination of the UE's position information.

In some embodiments, said determining the zone comprises: determining a beam-center zone of one beam of the plurality of beams if the RSRP of the beam is greater than that of any other one of the beams by at least a second RSRP threshold; otherwise, determining a beam-overlapping zone of the beams.

In some embodiments, the second RSRP threshold is three dB.

In some embodiments, said determining the zone comprises: determining a beam-center zone of one of the beams if the RSRP of the beam is greater than that of any other one of the beams by at least a second RSRP threshold; otherwise, determining a beam-unequally-overlapping zone of the beams if a sum of the RSRPs of two of the plurality of beams is greater than a weighted RSRP of any other one of the plurality of beams by at least a third RSRP threshold; otherwise, determining a beam-equally-overlapping zone of the plurality of beams.

In some embodiments, a weight for obtaining the weighted RSRP is two, and the third RSRP threshold is one dB.

In some embodiments, the first method further comprises: determining a weight and the third RSRP threshold from a system information block (SIB), the weight being for obtaining the weighted RSRP.

In some embodiments, said reporting the determined zone comprises: sending a PRACH signal corresponding to the determined zone.

In some embodiments, selected PRACH signal comprises three or more PRACH sequences; the three or more PRACH sequences comprises three or more repetitions of a same PRACH sequence if the determined zone is a beam-center zone; or the three or more PRACH sequences comprises three or more different PRACH sequences if the determined zone is a beam-overlapping zone.

According to one aspect of this disclosure, there is provided an apparatus comprising: a transmitter; a receiver; and a processor functionally coupled to the transmitter and the receiver for performing the above-described first method. In this disclosure, the apparatus may be a device such as a user equipment, or a communication device, or it may be a chipset or a module or a component of the device.

According to one aspect of this disclosure, there is provided one or more non-transitory computer-readable storage devices comprising computer-executable instructions, wherein the instructions, when executed, cause one or more processing units to perform the above-described first method.

According to one aspect of this disclosure, there is provided a second method comprising: transmitting SSBs via a plurality of synchronization beams towards an area, the plurality of synchronization beams associated with three or more beam layers; each beam layer comprises one or more of the plurality of synchronization beams; majorities of coverage areas of the three or more beam layers are overlapping; any two synchronization beams of different beam layers cover different coverage areas; and the one or more synchronization beams of each beam layer are associated with respective beam IDs.

In some embodiments, the plurality of synchronization beams are partitioned into one or more layout core patterns (LCPs), each LCP comprising three or more overlapping synchronization beams each from a respective one of the three or more beam layers.

In some embodiments, the plurality of synchronization beams form three beam layers, and each LCP comprises three mutually overlapping synchronization beams each from a respective one of the three or more beam layers.

In some embodiments, the three or more beam layers are associated with different frequencies.

In some embodiments, the plurality of synchronization beams are identifiable via one or more characteristics of the SSBs thereof.

In some embodiments, the one or more characteristics of the SSBs are one or more of one or more characteristics of a frequency domain, one or more characteristics of a time domain, one or more characteristics of a code domain, one or more characteristics of a space domain, and content of the SSBs.

In some embodiments, the second method further comprises: receiving position information from a user equipment (UE) in the area; and transmitting a data beam towards a direction based on the received position information for data communication with the UE.

In some embodiments, the position information comprises the IDs of one or more of the plurality of synchronization beams associated with different beam layers, a position of the UE, or an ID of a zone that the UE is located therein.

In some embodiments, said transmitting the data beam towards the direction based on the received position information comprises: transmitting the data beam towards the position of the UE or the zone that the UE is located therein; and the data beam has a size smaller than that of each of the plurality of synchronization beams.

According to one aspect of this disclosure, there is provided a radio access network (RAN) comprising: at least one transmitter; at least one receiver; and at least one processor functionally coupled to the at least one transmitter and the at least one receiver for performing the above-described second method. In this disclosure, the RAN may be a base station, a central unit and/or a distributed unit, components of the base station, and/or the like.

According to one aspect of this disclosure, there is provided one or more non-transitory computer-readable storage devices comprising computer-executable instructions, wherein the instructions, when executed, cause one or more processing units to perform the above-described second method.

According to one aspect of this disclosure, there is provided a communication system comprising at least one above-described apparatus performing the above-described first method and at least one RAN performing the above-described second method.

In summary, the communication systems, apparatuses, methods, and non-transitory computer-readable storage devices disclosed herein provides various benefits such as:
alleviating the cell-edge issue and enhancing the SSB link budget by exploiting an overlapping beam layout for SSB transmission, which achieves a rather uniform RSRP across the coverage region;
providing simple methods to partition a service area and to locate the UE position using the synchronization beams;
enabling adaptive beam deployment and/or (re-)configuration for data transmission with reduced overhead of reference signal transmission for beam refinement, reduced inter-beam interference for data channel, enhanced resource utilization and capacity, and enhanced non-terrestrial TRP energy efficiency;
supporting deployment of narrow beams for data-transmission at a low overhead;
enhancing the link budget for SSB and PRACH signals transmission and providing an accurate estimate of the UE location based on the uplink measurements; and
facilitating beam/cell switching as the measurements for adjacent cells may be available in advance before the UE moves to the edge of the currently serving cell.

### BRIEF DESCRIPTION OF THE DRAWINGS

FIG. 1 is a simplified schematic diagram showing the beam layout deployed in a conventional non-terrestrial network (NTN) system;

FIG. 2 is a simplified schematic diagram showing the structure of a communication system, according to some embodiments of this disclosure;

FIG. 3 is a simplified schematic diagram of a controlling device of a communication network of the communication system shown in FIG. 2;

FIG. 4 is a simplified schematic diagram of a transmit-receive point (TRP) of the communication system shown in FIG. 2;

FIG. 5 is a simplified schematic diagram of a user equipment (UE) of the communication system shown in FIG. 2;

FIG. 6 is a schematic diagram showing a layout core pattern (LCP) for deploying a plurality of synchronization beams in a service area of the communication system shown in FIG. 2, according to some embodiments of this disclosure, wherein the coverage area of each synchronization beam is represented as a hexagon;

FIG. 7 is a schematic diagram showing the beam layout of a plurality of synchronization beams deployed in a service area of the communication system shown in FIG. 2 by arranging the synchronization beams as a plurality of LCPs offset from each other, according to some embodiments of this disclosure;

FIGS. 8A to 8C are schematic diagrams showing different beam layers of the beam layout shown in FIG. 7;

FIG. 9 is a schematic diagram illustrating the beam layout shown in FIG. 7 wherein different beam layers are rendered using different hatching and line styles;

FIG. 10 shows the combined reference-signal received power (RSRP) of a plurality of signal beams arranged based on the conventional beam-layout pattern shown in FIG. 2;

FIG. 11 shows the greatest RSRP of a plurality of synchronization beams arranged according to the beam-layout pattern shown in FIG. 7;

FIG. 12 is a flowchart showing the steps of a cell search and system acquisition procedure performed by the communication system shown in FIG. 2 based on the beam layout shown in FIG. 7, according to some embodiments of this disclosure, wherein a UE of the communication system shown in FIG. 2 measures the RSRPs of the SSBs or the synchronization beams of different beam layers, and determines its location using triangulation based on the measured RSRPs;

FIG. 13 is a schematic diagram showing the triangulation used in the cell search and system acquisition procedure shown in FIG. 12;

FIG. 14 is a schematic diagram showing partitioning a service area having a beam layout shown in FIG. 7 into a plurality of beam-center zones and beam-overlapping zones;

FIG. 15 is a schematic diagram showing further partitioning a beam-overlapping zone into beam-unequally-overlapping zones and a beam-equally-overlapping zone;

FIG. 16 is a flowchart showing the steps of a cell search and system acquisition procedure performed by the communication system shown in FIG. 2 based on the beam layout shown in FIG. 14 or 15, according to some embodiments of this disclosure, wherein a UE of the communication system shown in FIG. 2 measures the RSRPs of the SSBs or the synchronization beams, and determines the zone that the UE is located therein;

FIG. 17 is a flowchart showing the steps of an initial access and data communication procedure performed by the communication system 100 shown in FIG. 2 based on the beam layout shown in FIG. 14 or 15, according to some embodiments of this disclosure;

FIG. 18A is a schematic diagram showing a physical random access channel (PRACH) signal having a plurality of repetitions of a single PRACH sequence corresponding to a synchronization beam when a UE is in the beam-center zone of the synchronization beam;

FIG. 18B is a schematic diagram showing a physical random access channel (PRACH) signal having a combination of three PRACH sequences corresponding to three overlapping synchronization beams when a UE is in the beam-overlapping zone of the three overlapping synchronization beams;

FIG. 19 is a flowchart showing an exemplary SSB detection and preamble transmission procedure performed by a UE, according to some embodiments of this disclosure;

FIG. 20A is a schematic diagram showing correspondence between receive beam directions and preamble resources/repetitions when a UE is located near a beam center;

FIG. 20B is a schematic diagram showing correspondence between receive beam directions and preamble resources/repetitions when a UE is located in a beam-overlapping zone;

FIG. 21A is a schematic diagram showing the receive beam directions when a UE is located near a beam center;

FIG. 21B is a schematic diagram showing the receive beam directions when a UE is located in a beam-overlapping zone;

FIG. 22A is a schematic diagram showing two adjacent cells each comprising three overlapping synchronization beams;

FIG. 22B is a schematic diagram showing the two adjacent cells shown in FIG. 22A with gaps added between the synchronization beams for better illustration of the coverage areas of different beams;

FIG. 23A is a schematic diagram showing two adjacent coverage areas each being covered by three overlapping synchronization beams transmitted from a respective non-terrestrial transmit-receive point (TRP) of the communication system shown in FIG. 2; and

FIG. 23B is a schematic diagram showing the two coverage areas shown in FIG. 23A with gaps added between the synchronization beams for better illustration of the coverage areas of different beams.

### DETAILED DESCRIPTION

### A. System Structure

Turning now to FIG. 2, a communication system is shown and is generally identified using reference numeral 100. As shown, the communication system 100 comprises a plurality of transmit-receive points (TRPs) 102 forming a radio access network (RAN) 104 in communication with a plurality of user equipments (UEs) 114 for providing wireless communication services to the UEs 114 such that the UEs 114 may access one or more public switched telephone networks (PSTNs) 106, the Internet 108, and other networks 11o via a communication network 112 to make phone calls (to, for example, other UEs 114, landline phones (not shown), and/or the like), exchanging data (for example, sending/receiving emails, sending/receiving instant messages, and/or the like), accessing contents (such as text content, audio content, and/or video content), and/or the like. Herein, a TRP 102 may also be referred to as a communication node, a gNodeB (next generation NodeB, also called a “gigabit” NodeB or a “gNB”), a base station, an access point, and/or the like, and may comprise a plurality of terrestrial TRPs 102A and a plurality of non-terrestrial TRPs 102B.

Each RAN 104 may correspond to a serving cell (or simply “cells”; also identified using reference numeral 104). Herein, a serving cell is a combination of downlink and optionally uplink resources. The linking between the carrier frequency of the downlink resources and the carrier frequency of the uplink resources is indicated in the system information transmitted on the downlink resources. A serving cell may also be defined as a radio network object that may be uniquely identified by a UE 114 from a cell identification (that is physical cell identifier (ID)) that is broadcasted (via a synchronization signal and physical broadcast channel (PBCH) block (SSB)) over a geographical area from one or more TRPs 102. A cell may be in either the frequency division duplex (FDD) mode or the time division duplex (TDD) mode.

Herein, an SSB refers to a synchronization signal block and may also be referred to as a synchronization signals (SS) and physical broadcast channel (PBCH) (SS/PBCH) block. In NR, SSB comprises a combination of two major components:
Synchronization signals: including the primary synchronization signal (PSS) and the secondary synchronization signal (SSS); and
PBCH: including PBCH demodulation reference signal (DMRS) and PBCH.

As described in https://www.rfwireless-world.com/5G/5G-NR-SSB-SS-PBCH.html, an SSB may be mapped to four (4) orthogonal frequency-division multiplexing (OFDM) symbols in the time domain and 20 resource block (RBs) or 240 subcarriers in the frequency domain. In 5G NR, beam sweeping may be used for SSB transmission, wherein a plurality of SSBs are transmitted periodically at about 20 milliseconds (ms) intervals. More specifically, about 64 SSBs are transmitted in different beams within a SS burst-set period. An SSB in a SS burst set is transmitted in a window of about 5 ms. Frequency location of SSB is configured by upper layer stack to support sparser search raster in order to detect SSB.

Following are the possible candidate SSB locations (L) within a SS burst set. Each slot in time domain consists of two (2) SS block locations for <6 GHz for 15 KHz/30 KHz. Each slot consists of 2 SS blocks in 120 KHz for >6 GHz.
L=4 (up to 3 GHz)
L=8 (From 3 GHz to 6 GHz)
L=64 (From 6 GHz to 52.6 GHz)
Both SS and PBCH detection helps UE synchronize with the gNB (i.e. 5G base station) during initial network entry phase.

Referring to FIG. 2 again, the PSTN 106 may include circuit switched telephone networks for providing plain old telephone service (POTS). The Internet 108 may include a network of computers and subnets (intranets) or both, and incorporate protocols, such as IP, TCP, UDP, and/or the like.

The communication network 112 comprises one or more controlling devices 120 in communication with the TRPs 102 to provide various services such as voice, data, and other services to the UEs 114. The one or more controlling devices 120 of the communication network 112 may also serve as a gateway access between (i) the TRPs 102 or UEs 114 or both, and (ii) other networks (such as the PSTN 106, the Internet 108, and the other networks 110).

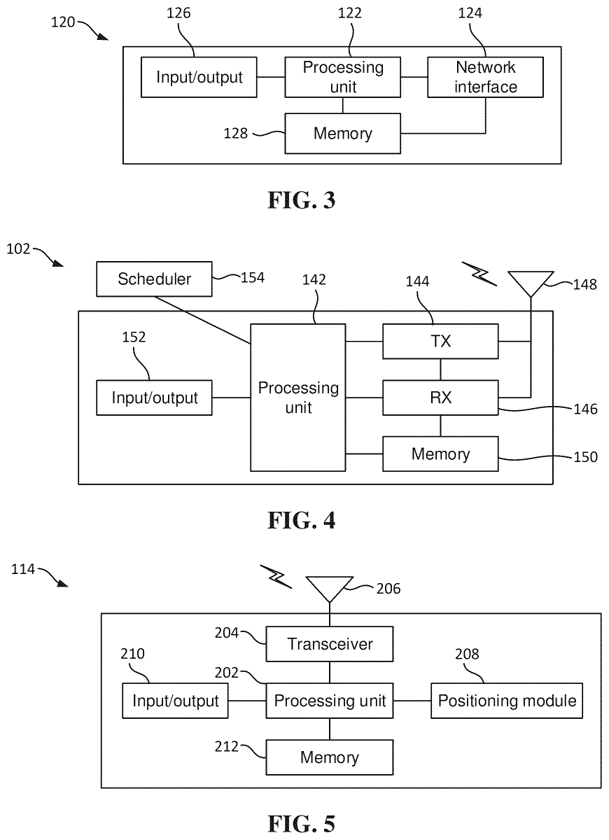

FIG. 3 is a simplified schematic diagram of the controlling device 120. As shown, the controlling device 120 comprises at least one processing unit 122 (also denoted “processor”), at least one network interface 124, one or more input/output components or interfaces 126, and at least one memory 128 (also denoted “storage device” hereinafter).

The processing unit 122 is configured for performing various processing operations and may comprise a microprocessor, a microcontroller, a digital signal processor, a field programmable gate array (FPGA), an application specific integrated circuit (ASIC), and/or the like.

The network interface 124 comprises a circuitry for directly or indirectly (that, via one or more intermediate devices) communicating with other devices such as the TRPs 102, the PSTN 106, the Internet 108, and other networks 11o using suitable wired or wireless communication technologies and suitable protocols.

Each input/output component 126 enables interaction with a user or other devices in the communication system 100. Each input/output device 126 may comprise any suitable structure for providing information to or receiving information from a user and may be, for example, a speaker, a microphone, a keypad, a keyboard, a display, a touch screen, and/or the like.

Each memory 128 may comprise any suitable volatile and/or non-volatile storage and retrieval components such as random access memory (RAM), read only memory (ROM), hard disk, optical disc, subscriber identity module (SIM) card, solid-state memory modules, memory stick, secure digital (SD) memory card, and/or the like. The memory 128 may be used for storing instructions executable by the processing unit 122 and data used, generated, or collected by the processing unit 122 and/or the network interface 124. For example, the memory 126 may store software instructions or modules executable by the processing unit 122 for implementing some or all of the functionalities and/or embodiments of the controlling device 120 described herein. The memory 126 may also store coverage information of the TRPs 102 (described in more detail later) in, for example, a database thereof.

Referring back to FIG. 2, the TRPs 102 comprise a plurality of terrestrial TRPs 102A and a plurality of non-terrestrial TRPs 102B. Herein, a terrestrial TRP 102A is generally deployed on the ground (including on ground-based infrastructures such as buildings, towers, and/or the like). The terrestrial TRP 102A may typically comprise a plurality of components such as one or more transmitters and receivers, one or more base station controllers (BSCs), radio network controllers (RNCs), relay nodes, elements, and/or the like. Each terrestrial TRP 102A (or more specifically the base station thereof) transmits and/or receives wireless signals within a particular geographic region or area (that is, a “coverage area” of a serving cell, which may be further partitioned into a plurality of sectors, and a terrestrial TRP 102A may, for example, employ multiple transceivers to provide service to multiple sectors. In some embodiments, there may be established pico or femto cells where the radio access technology supports such. In some embodiments, multiple transceivers may be used for each cell, for example using multiple-input multiple-output (MIMO) technology.

As those skilled in the art understand, cellular coverage (that is, the coverage of the terrestrial TRPs 102A) typically varies depending on the regions. For example, cellular coverage is typically strong and widely available in regions with dense cellular infrastructure deployment; examples of such regions may be urban regions with high population density where carriers are more willing to deploy more cellular infrastructure. On the other hand, cellular coverage may be sparse and poorly available in regions with sparse cellular infrastructure deployment; examples of such regions may be rural or remote regions with low population density where carriers are less motivated to deploy cellular infrastructure.

On the other hand, a non-terrestrial TRP 102B is a TRP generally deployed above ground or in the space such as a communication satellite or a high altitude platform stations (HAPS) (for example, a drone, a balloon, an airship, an aircraft, or the like). In various embodiments, a non-terrestrial TRP 102B may be permanently or semi-permanently deployed (such as a non-terrestrial TRP 102B in the form of a communication satellite, a communication balloon or airship anchored at a fixed location, or the like), or may be temporarily deployed (for example, a non-terrestrial TRP 102B in the form of a drone, a balloon, or an airship temporarily deployed about a location) for supporting an anticipated intensive-communication event such as a concert, a game, or the like, wherein the deployment of the non-terrestrial TRP 102B may be cancelled after the event.

The terrestrial TRP 102A and non-terrestrial TRP 102B may have a similar structure although they may be different in some aspects such as their communication bandwidths, communication technologies, protocols, and/or the like. FIG. 4 is a simplified schematic diagram of a TRP 102. As shown, the TRP 102 comprises at least one processing unit 142, at least one transmitter 144, at least one receiver 146, one or more antennas 148, at least one memory 150, and one or more input/output components or interfaces 152. A scheduler 154 may be coupled to the processing unit 142. The scheduler 154 may be included within or operated separately from the TRP 102.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like.

Each transmitter 144 may comprise any suitable structure for generating signals for wireless transmission to one or more UEs 114 or other devices. Each receiver 146 may comprise any suitable structure for processing signals received wirelessly from one or more UEs 114 or other devices. Although shown as separate components, at least one transmitter 144 and at least one receiver 146 may be integrated and implemented as a transceiver. Each antenna 148 may comprise any suitable structure for transmitting and/or receiving wireless signals. Although a common antenna 148 is shown in FIG. 4 as being coupled to both the transmitter 144 and the receiver 146, one or more antennas 148 may be coupled to the transmitter 144, and one or more separate antennas 148 may be coupled to the receiver 146.

Each memory 150 may comprise any suitable volatile and/or non-volatile storage and retrieval components such as RAM, ROM, hard disk, optical disc, SIM card, solid-state memory modules, memory stick, SD memory card, and/or the like. The memory 150 may be used for storing instructions executable by the processing unit 142 and data used, generated, or collected by the processing unit 142. For example, the memory 150 may store software instructions or modules executable by the processing unit 142 for implementing some or all of the functionalities and/or embodiments of the TRP 102 described herein.

Each input/output component 152 enables interaction with a user or other devices in the system 100. Each input/output device 152 may comprise any suitable structure for providing information to or receiving information from a user and may be, for example, a speaker, a microphone, a keypad, a keyboard, a display, a touch screen, a network communication interface, and/or the like.

Referring back to FIG. 2, the TRPs 102 may communicate with the UEs 114 over one or more air interfaces 118 using any suitable wireless communication links such as radio frequency (RF), microwave, infrared (IR), and/or the like. The air interfaces 118 may utilize any suitable channel access methods such as time division multiple access (TDMA), frequency division multiple access (FDMA), orthogonal FDMA (OFDMA), single-carrier FDMA (SC-FDMA), code division multiple access (CDMA), wideband CDMA (WCDMA), and/or the like.

The air interfaces 118 may use any suitable radio access technologies such as universal mobile telecommunication system (UMTS), high speed packet access (HSPA), HSPA+(optionally including high speed downlink packet access (HSDPA), high-speed uplink packet access (HSUPA), or both), Long-Term Evolution (LTE), LTE-A, LTE-B, IEEE 802.11, 802.15, 802.16, CDMA2000, CDMA2000 1×, CDMA2000 EV-DO, IS-2000, IS-95, IS-856, global system for mobile communications (GSM), enhanced data rates for GSM evolution (EDGE), GSM EDGE radio access network (GERAN), 5G New Radio (NR), standard or non-standard satellite internet access technologies, and/or the like. Moreover, the communication system 100 may use multiple channel access functionality. Of course, other multiple access schemes and wireless protocols may be used.

Herein, a UE 114 generally refers to a wireless device that may join the communication system 100 via a joint initial access procedure (described in more detail later). In various embodiments, a UE 114 may be a wireless device used by a human or user (such as a smartphone, a cellphone, a personal digital assistant (PDA), a laptop, a computer, a tablet, a smart watch, a consumer electronics device, and/or the like. A UE 114 may alternatively be a wireless sensor, an Internet-of-things (IoT) device, a robot, a shopping cart, a vehicle, a smart TV, a smart appliance, or the like. Depending on the implementation, the UE 114 may be movable autonomously or under the direct or remote control of a human, or may be positioned at a fixed position. In some embodiments, a UE 114 may be a network device (such as a TRP 102, a wireless transmit/receive unit (WTRU), a mobile station, a fixed or mobile subscriber unit, a machine type communication (MTC) device, a device of the communication network 112, or the like) which is considered as a UE when it is powered on and joins the communication system 100 via the joint initial access procedure; and then acts as a network device after the joint initial access procedure is completed). In some embodiments, the UEs 114 may be multimode devices capable of operation according to multiple radio access technologies and incorporate multiple transceivers necessary to support such.

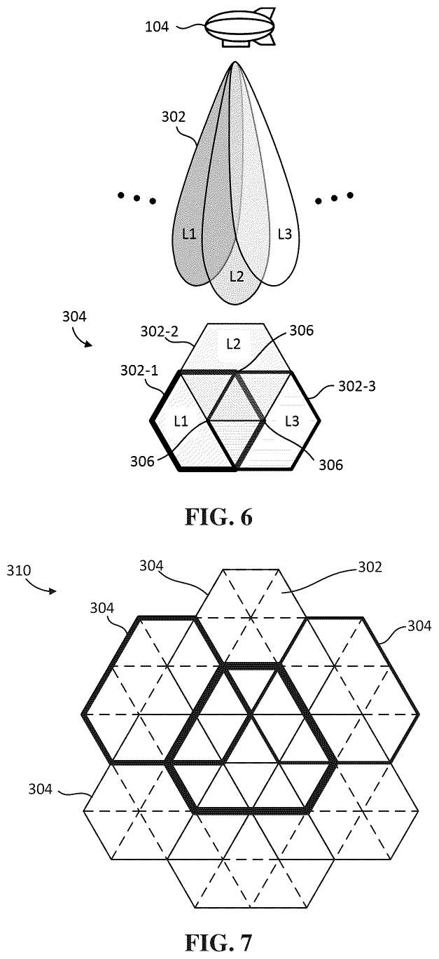

FIG. 5 is a simplified schematic diagram of a UE 114. As shown, the UE 114 comprises at least one processing unit 202, at least one transceiver 204, at least one antenna or network interface controller (NIC) 206, at least one positioning module 208, one or more input/output components 210, and at least one memory 212.

The processing unit 202 is configured for performing various processing operations such as signal coding, data processing, power control, input/output processing, or any other functionalities to enable the UE 114 to join the communication system 100 and operate therein. The processing unit 202 may also be configured to implement some or all of the functionalities and/or embodiments of the UE 114 described in this disclosure. The processing unit 202 may comprise a microprocessor, a microcontroller, a digital signal processor, a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like.

The at least one transceiver 204 may be configured for modulating data or other content for transmission by the at least one antenna 206. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning anchors. The positioning module 208 may use the transceiver 204 and antenna 206 for communicating with the positioning anchors, or may comprise separate transceiver and antenna for communicating with the positioning anchors. In some embodiments, the positioning anchors may be positioning devices such as navigation satellites and/or HAPS separated from the non-terrestrial TRPs 102B. For example, the navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning anchors may be devices (for example, navigation satellites and/or HAPS) acting as both positioning anchors for providing positioning reference signals and as non-terrestrial TRPs 102B.

The one or more input/output components 210 is configured for interaction with a user or other devices in the system 100. Each input/output component 210 may comprise any suitable structure for providing information to or receiving information from a user and may be, for example, a speaker, a microphone, a keypad, a keyboard, a display, a touch screen, a network communication interface, and/or the like.

The at least one memory 212 is configured for storing instructions executable by the processing unit 202 and data used, generated, or collected by the processing unit 202. For example, the memory 212 may store software instructions or modules executable by the processing unit 202 for implementing some or all of the functionalities and/or embodiments of the UE 114 described herein. Each memory 212 may comprise any suitable volatile and/or non-volatile storage and retrieval components such as AM, ROM, hard disk, optical disc, SIM card, solid-state memory modules, memory stick, SD memory card, and/or the like.

For ease of description, in the following, a communication system 100 having one or more terrestrial TRPs 102A and no non-terrestrial TRPs 102B is denoted a terrestrial network (TN) system, and a communication system 100 having one or more non-terrestrial TRPs 102B is denoted a non-terrestrial network (NTN) system. Those skilled in the art will appreciate that an NTN system 100 may also comprise one or more terrestrial TRPs 102A. Moreover, while an NTN system 100 is described as an example in the following description, those skilled in the art will appreciate that the methods describe below may also be used for TN systems, and/or the terrestrial TRPs 102A of NTN systems, and/or any radio-access architectures in which beam-based communication is supported or used, especially when there is an issue with the coverage, or where the overhead for reference-signal transmission should be limited.

### B. Beam Layout Configuration of Non-Terrestrial TRPS and Cell Search and System Acquisition Methods

As described above, conventional NTN systems use a regular beam-layout pattern to transmit both SSB and data channel signals. However, such a regular beam-layout pattern may result in non-efficient utilization of the resources because of the inter-beam interference caused by the partial overlaps of beams/cells (required to avoid coverage holes). A prior-art method in the context of NR is to refine the beam for data transmission by transmitting narrower channel-state-information reference signal (CSI-RS). Then, based on the measurement result reported from the UE, data is transmitted quasi co-located (QCL) with the best CSI-RS beam. However, this method may result in significant overhead (for reference signal (RS) transmission) and excessive latency which should be avoided in the context of NTNs.

The conventional beam-layout methods may not meet the spatiotemporal variations in user traffic demands. Moreover, such conventional beam-layout methods suffer from a low availability and/or throughput, especially at the cell/beam-edge regions because of the variations of the reference-signal received power (RSRP) and due to inter-beam interference in the overlapping regions. Hence, the resources may not be efficiently utilized.

The following describes a communication system 100 using a beam layout with highly overlapping beam layers and corresponding cell search and system acquisition methods for solving the above-described beam-edge issue (thus extending the beam coverage) while enabling deployment of narrow beams at a low-overhead to avoid inter-beam interference for data transmission.

In various embodiments, a plurality of synchronization beams are used for transmitting SSBs from the RAN 104 to the UEs 114 in a service area. The plurality of synchronization beams are deployed according to a beam layout that partitions the synchronization beams into three or more beam layers wherein the beam layers are substantially overlapping (that is, the majorities of the coverage areas of the beam layers are overlapping; described in more detail later). Thus, the plurality of synchronization beams are highly overlapping such that a UE 114 at a position of a weaker signal strength of a beam of a first beam layer (for example, around the edge of the beam of the first beam layer) may be located at a position of a much stronger signal strength of a beam of a second beam layer (for example, close to or adjacent the center of the beam of the second beam layer). UEs 114 within such majorities of the coverage areas of the beam layers may use the methods described below for initial access. UEs 114 within the minorities of the coverage areas of the beam layers may use conventional methods for initial access.

In some embodiments, the edge of a synchronization beam includes the positions where the RSRPs at those positions are smaller than the RSRP at the center of the synchronization beam by 3 decibels (dB). In some other embodiments, the edge of a synchronization beam includes the positions where the RSRPs at those positions are null (that is, approximately zero). In some embodiments, the size of the synchronization beam is defined as a circle with a radius equal to the distance from the center to the edge thereof.

In some embodiments, the layout of the synchronization beams may be established by repeating and offsetting a layout core pattern (LCP) in the coverage area of the RAN 104. FIGS. 6 and 7 are schematic diagrams showing a layout of the synchronization beams, according to some embodiments of this disclosure.

As shown, a RAN 104 (having one or more non-terrestrial TRPs 102B; not shown) transmits a plurality of synchronization beams 302 towards the ground. For ease of description, the plurality of synchronization beams 302 have the same coverage size on the ground.

As shown in FIG. 6, the RAN 104 transmits a plurality of R adjacent synchronization beams 302 towards an area 304 (denoted a “LCP” hereinafter) wherein the R adjacent synchronization beams 302 are substantially overlapping (and are highly overlapping compared to the conventional beam-layout pattern) such that a UE 114 (not shown) at a position of the area 304 with a weaker signal strength of a first synchronization beam (for example, around the edge of the first synchronization beam 302-1) may be located at a position of the area 304 with a much stronger signal strength of a second synchronization beam (for example, close to or adjacent the center of the second synchronization beam 302-2).

In the embodiment shown in FIG. 6, R=3 and the three adjacent synchronization beams 302-1, 302-2, and 302-3 are mutually overlapping to form the LCP 304, wherein the centers of the three synchronization beams 302-1 to 302-3 are at equal distances with respect to each other, and the edge of each synchronization beam crosses the centers 306 of the other two synchronization beams.

As shown in FIG. 7, the plurality of synchronization beams 302 may be deployed in a service area 310 by repeating and offsetting the LCP 304 in a substantially overlapping manner such that a UE 114 (not shown) at a position of the service area 310 with a weaker signal strength of a synchronization beam may be located at a position of the service area 310 with a much stronger signal strength of another synchronization beam.

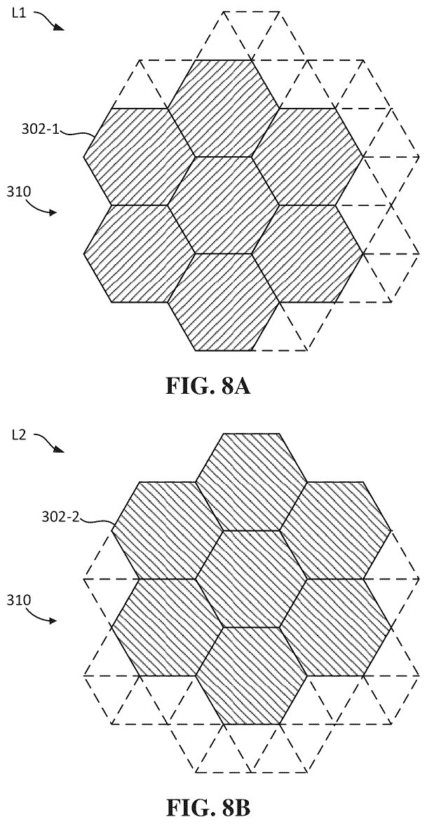

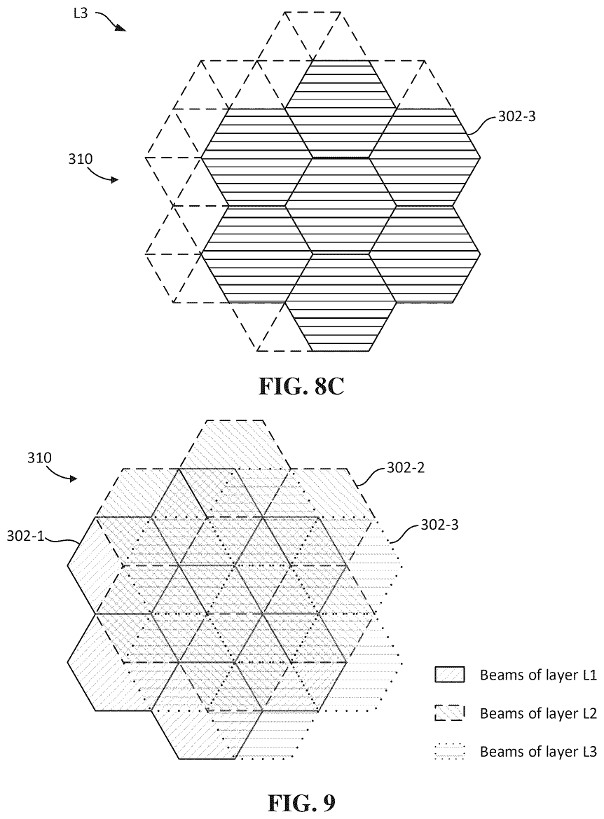

Such a beam layout generally partitions the plurality of synchronization beams 302 into R beam layers. For example, FIGS. 8A to 8C shows the beam layers L1, L2, and L3 of the beam layout shown in FIG. 7A, wherein the synchronization beams of beam layer L1 comprise all synchronization beams 302-1 of the LCPs 304 (see FIG. 6), the synchronization beams of beam layer L2 comprise all synchronization beams 302-2 of the LCPs 304, and the synchronization beams of beam layer L3 comprise all synchronization beams 302-3 of the LCPs 304. The beam layers L1, L2, and L3 are substantially overlapping (that is, the majorities of the coverage areas of the beam layers L1, L2, and L3 are overlapping), In each beam layer L1, L2, L3, the synchronization beams 302 thereof are non-overlapping. Moreover, any two synchronization beams of different layers cover different areas (that is, no two beams of different beam layers are fully overlapping).

FIG. 9 illustrates the beam layout shown in FIG. 7 (which is also the combination of FIGS. 8A to 8C), wherein synchronization beams of different layers are rendered using different hatching and line styles. As can be seen, at any position in the service area 310, the R synchronization beams 302 covering this position are from R different beam layers (in other words, the UE 114 always received one beam from each of the R beam layers). Moreover, in the exemplary beam layout shown in FIGS. 7 to 9, the edge of each synchronization beam 302 crosses the centers of a plurality of adjacent synchronization beams.

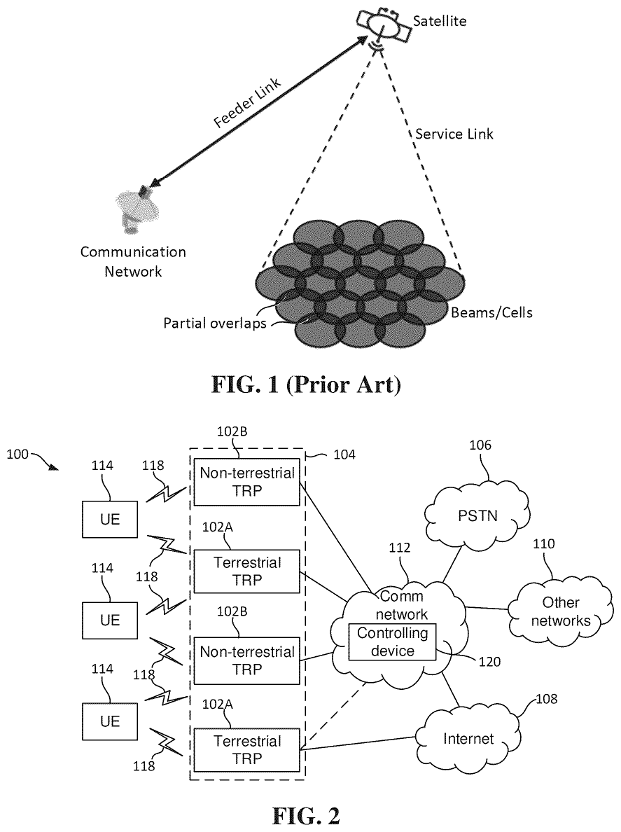

Those skilled in the art will appreciate that the beam size in the highly overlapping beam-layout pattern is generally greater than that in the conventional beam-layout pattern (see FIG. 1) for covering the same coverage average using the same number of beams.

Those skilled in the art will appreciate that applying repeating and offsetting LCPs 304 in the service area 310 of the RAN 104 is merely one way for deploying the R beam layers in the coverage area of the RAN 104, and other methods of deploying the R beam layers are readily available. For example, one may directly deploy the R beam layers as shown in FIGS. 8A to 8C in the service area 310 without using the concept of LCP.

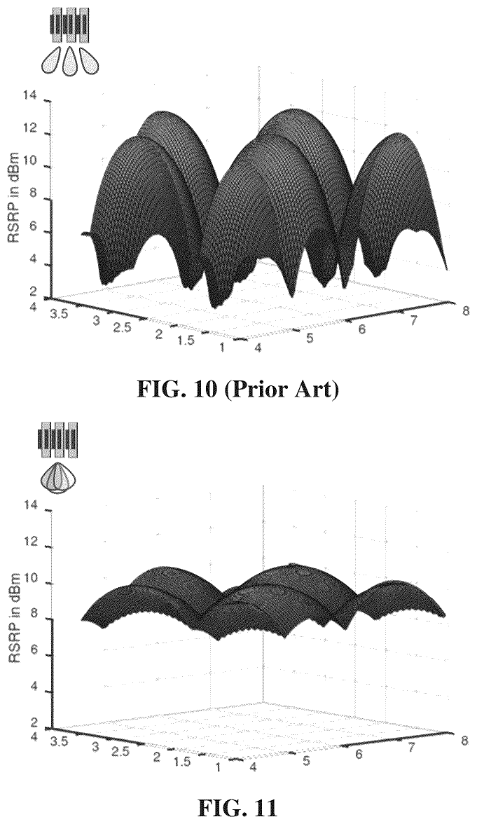

With above-described beam layout, a point in the service area 310 that is located at the edge of a synchronization beam may be near the center of another synchronization beam, thereby alleviating the cell-edge issue. As shown in FIG. 10 (the combined RSRP of a plurality of signal beams arranged based on the conventional beam-layout pattern shown in FIG. 1) and FIG. 11 (the greatest RSRP of a plurality of synchronization beams arranged according to the highly overlapping beam-layout pattern), the communication system 100 disclosed herein generally achieves more uniform RSRP distribution of the synchronization beams in the service area 310 that the communication system based on conventional beam-layout patterns. For example, as shown in FIGS. 10 and 11, the above-described beam layout with R=3 achieves the greatest RSRP at the beam edge at least 5 dB higher than the RSRP of a conventional beam layout at the same positions.

Herein, each beam layer comprises one or more unique or distinguishable characteristics for distinguishing it from other beam layers, thereby allowing a UE 114 to determine the beam layer that a detected (or received) beam is associated therewith. Examples of such unique or distinguishable characteristics may be one or more unique or distinguishable frequency characteristics (that is, characteristics in the frequency domain), time characteristics (that is, characteristics in the time domain), coding characteristics (that is, characteristics in the coding domain), spatial characteristics (that is, characteristics in the spatial domain), contents (that is, the data carried by the synchronization beams), and/or the like.

For example, in some embodiments, the beams 302 (and thus the SSBs thereof) of each beam layer are transmitted over different frequency bands. The UE 114 may determine the beam layers of the received synchronization beams based on the frequency bands of the SSBs. In some other embodiments, the SSBs of each beam layer may be transmitted in different time slots. The UE 114 may determine the beam layers of the received synchronization beams based on the time slots of the SSBs. In yet some other embodiments, each beam layer is assigned with a beam-layer identifier (ID) which is transmitted as the content of the SSBs of the beam layer.

Thus, those skilled in the art will appreciate that the unique or distinguishable characteristics of the beam layers may be considers as the beam-layer IDs.

Herein, the synchronization beams 302 of each beam layer may be configured such that each synchronization beam 302 may comprise one or more unique or distinguishable characteristics such as one or more unique frequency characteristics, time characteristics, coding characteristics, spatial characteristics, contents (that is, the data carried by the synchronization beams), and/or the like, to allow the UE 114 and/or the RAN 104 to distinguish the synchronization beams 302 in the same beam layer when they perform cell search and system acquisition. Such unique or distinguishable characteristics may be considered the beam IDs (also denoted “SSB IDs”).

For example, in some embodiments, the beams 302 are assigned with unique beam IDs or SSB IDs. In one example, the SSB IDs are classified into R sets such as ID₁=Rx, ID₂=Rx+1, ID₃=Rx+2, . . . , ID_{R}=Rx+R−1, where x takes values in a certain range to distinguish adjacent beams as needed. Thus, each SSB ID set IDᵢ (i=1, 2, 3, . . . , R) comprises the beam IDs of the corresponding beam layer. The UE 114 may decode the SSBs of the received synchronization beams to obtain the beam IDs.

In some other embodiments, the beams 302 of each beam layer are assigned with unique beam IDs (thus, beams of different beam layers may have the same beam IDs) which are transmitted with the SSB as the SSB IDs, and the SSBs of different beam layers are transmitted over different frequency bands. Thus, the beams 302 may be distinguished by their beam IDs and their frequency bands. In one example, the beams of each LCP 304 are assigned with the same beam ID (which is unique to the beam IDs of the beams of other LCPs). The UE 114 may decode the SSBs of the received synchronization beams to obtain the beam IDs, and determine the beam layers of the received synchronization beams based on the frequency bands of the SSBs.

In yet some other embodiments, the beams 302 of each beam layer are assigned with unique beam IDs which are transmitted with the SSB as the SSB IDs. While beams of different beam layers may have the same beam IDs, in these embodiments, the beams transmitted towards similar directions (for example, towards the same quadrant) do not have the same beam IDs. Although the UE 114 in these embodiments may not be able to distinguish the R received beams, when the UE 114 feeds back the RAN 104 during the cell search and system acquisition process, the RAN 104 may use the beam IDs fed back from the UE 114 to determine which beams are received by the UE 114.

In some embodiments, the distinguishable characteristics the beams 302 may be predefined in advance. In some other embodiments, the distinguishable characteristics the beams 302 such as the association between SSBs and beam layers may be notified from the RAN 104 to the UE 114 using, for example, the system information block (SIB). In these embodiments, the UE 114 first detects one SSB, reads the SIB, and determines the association between SSBs and beam layers by, for example, finding a reference to the resources where SSBs of other layers are transmitted. The UE 114 may also receive other configuration on how to partition the service area 310.

Thus, those skilled in the art will understand that the characteristics or resources of the beam layer 304 as a whole may be reused across the service area 310, thereby reducing the resources required for covering the service area 310.

With above-described beam layout, the cell search and system acquisition methods in various embodiments are now described. By using the cell search and system acquisition methods, the UE 114 may detect and measure SSBs across a plurality of (such as more than three) highly overlapping beams, and then use the SSB/beam with the greatest RSRP or a set of SSBs/beams whose RSRPs are greater than a threshold for cell search and system acquisition, and further for initial-access procedure to the cell.

In some embodiments, the UE 114 may determine its location with respect to the beam layout using triangulation based on the SSB measurements and send a message to report its position to the RAN 104.

In some embodiments, the service area 310 is further partitioned into a plurality of zones. The UE 114 may determine the zone it is located therein based on the SSB measurements and report its zone to the RAN 104. In some embodiments, the UE 114 in the idle mode may use a certain preamble repetition pattern (which comprises sequences that are associated with the detected SSBs) to report to the RAN 104 so as to allow the RAN 104 to derive the position of the UE 114. The UE 114 may also send certain feedback messages to indicate its position.

In some embodiments, by determining and reporting the position of the UE (even a rough estimate of the UE position such as the zone the UE is located therein), the RAN may adaptively deploy a narrow beam for data transmission with the UE 114 without the signaling overhead of sweeping multiple CSI-RS for beam refinement.

Thus, the communication system 100 disclosed herein provides a method for UEs 114, especially those in the remote or underserved areas, to access non-terrestrial TRPs 102B such as satellites and/or HAPS. Particularly, the communication system 100 disclosed herein extends the coverage (by enhancing the link budget for SSB, physical random access channel (PRACH), and subsequent transmissions) and facilitates beam refinement without using any global navigation satellite system (GNSS) for UE positioning.

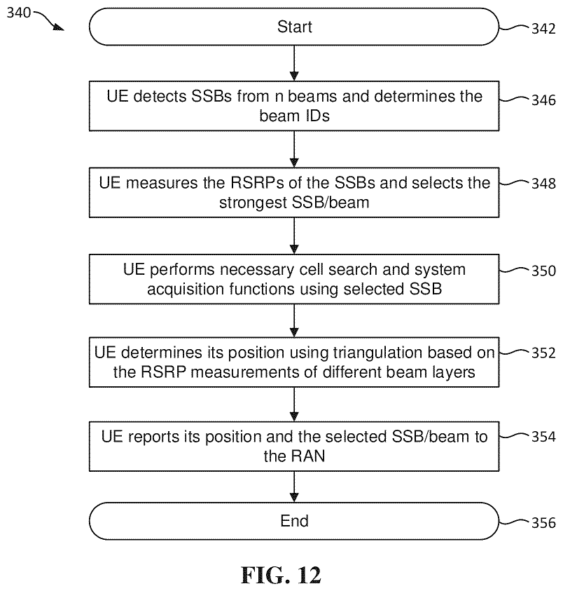

FIG. 12 is a flowchart showing the steps of a cell search and system acquisition procedure 340 performed by a UE 114, according to some embodiments of this disclosure.

In this example, the RAN 104 (having one or more non-terrestrial TRPs 102B) transmits a plurality of synchronization beams towards the ground for transmitting SSBs from the RAN 104 to the UEs 114 in a service area 310, wherein the synchronization beams are arranged in a highly overlapping beam-layout having R beam layers as described above. SSBs of different beam layers are transmitted over different beam-transmission frequency bands that are preconfigured and known to the UE 114 before the UE 114 executing the cell search and system acquisition procedure 340.

A UE 114 not yet connected to the RAN 104 (for example, the UE 114 is in the idle mode) may start the procedure 340 (step 342). The UE 114 detects n (n≥R) synchronization beams 302, retrieves SSBs therefrom, and determines the beam IDs of the detected synchronization beams 302 (step 346).

At this step, the UE 114 tunes to each beam-transmission frequency band and detects SSBs over a period of time to determine an SSB that has a sufficiently strong receiving power (for example, the RSRP being greater than a threshold). Detecting the SSBs may be based on decoding the primary synchronization signal (PSS) and secondary synchronization signal (SSS) and combining the SSBs of the same burst groups carrying the same synchronization sequences such as the PSS and SSS. The UE 114 then determines a synchronization beam in each beam layer that has the strongest RSRP. After all R beam-transmission frequency bands are scanned, R beams (each corresponding to a respective beam layer) overlapping at the position of the UE 114 are determined.

At step 348, after decoding the PSS and SSS, the UE 114 measures the RSRPs of the SSBs over a period of time, and selects the SSB or synchronization beam with the greatest RSRP (that is, the strongest signal strength). As those skilled in the art will understand, selecting the SSB or synchronization beam implies the determination of the position of the UE 114.

At step 350, the UE 114 uses the selected SSB to perform necessary cell search and system acquisition functions such as detecting the primary synchronization signal (PSS) and secondary synchronization signal (SSS) to acquire information of frequency and time synchronization and the physical cell ID (PCI), decoding physical broadcast channel (PBCH), and obtaining physical downlink control channel (PDCCH) and physical data shared channel (PDSCH) for remaining minimum system information (RMSI) and other system information (OSI), and/or the like.

At step 352, the UE 114 determines its position based on the RSRP measurements. More specifically, the UE 114 compares the measured RSPRs of the n synchronization beams to determine the relative distances between the UE 114 and the centers of the synchronization beams. As those skilled in the art will appreciate, such relative distances may be the physical distances between the UE 114 and the centers of the synchronization beams, or may values proportional to the physical distances. For example, the relative distances may be proportional to and represented by the measured RSPRs of the n synchronization beams. Alternatively, the relative distances may be the ratios of the measured RSPRs of the n synchronization beams over a reference RSPR (which may be one of the measured RSPRs).

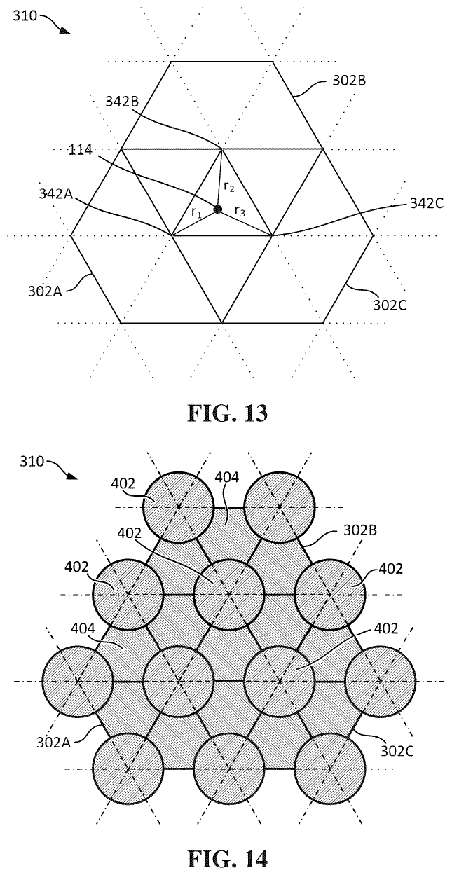

Then, the UE 114 may use triangulation to determine its relative position with respect to the beam layers, as shown in FIG. 13 wherein r₁, r₂, and r₃ are the determined relative distances between the UE 114 and the centers 282A, 282B, and 282C of the overlapping synchronization beams 302A, 302B, and 302C, respectively. As the beam layers (which includes the positions of the centers 282A, 282B, and 282C of the overlapping synchronization beams 302A, 302B, and 302C) are known to the UE 114, the UE 114 may calculate its position with respect to the beam layers by using triangulation based on the determined distances r₁, r₂, and r₃.

At step 354, the UE 114 reports its calculated relative position and information of the selected SSB (such as the beam IDs thereof) to the RAN 104 (for example, via PRACH) for performing an initial-access procedure to a serving cell.

Those skilled in the art will understand that the initial-access procedure may include the UE 114 transmitting an RRC connection request message to establish an RRC connection, an RRC connection re-establish request message to re-stablish the RRC connection, or an RRC connection resume request message to resume the RRC connection. Or the initial-access procedure may initiate uplink data transmission directly (i.e., without transition to RRC active state firstly) in RRC idle state or in RRC inactive state.

The cell search and system acquisition procedure 240 is then completed (step 356).

As will be described in more detail later, the RAN 104 may then use the relative position of the UE 114 (relative to the beam layers) for on-demand deployment of narrow beams, thus avoiding inter-beam interference for data transmission.

Those skilled in the art will understand that the data transmission may include user data, downlink RRC messages such as RRC connection setup, RRC re-establishment, RRC resume, or RRC configuration message, or other messages, and this disclosure does not limit it.

In some embodiments, the beam-transmission frequency bands are unknown to the UE 114 before the UE 114 executing the cell search and system acquisition procedure 340. As described above, the UE 114 in these embodiments first detects one SSB, reads the SIB, and determines the association between SSBs and beam layers by finding a reference to the resources where SSBs of other layers are transmitted. The UE 114 may also receive other configuration on how to partition the service area 310.

In some embodiments, the UE 114 does not have the knowledge of the beam layout. At step 352, the UE 114 sends the determined distances and information of the selected SSB to the RAN 104 which has the knowledge of the beam layout. The RAN 104 then calculates the position of the UE 114 using the knowledge of the beam layout, the beam IDs, and the determined distances.

Those skilled in the art will appreciate that, in some embodiments, the precise position of a UE 114 may not be required. Rather, the RAN 104 in these embodiments may only need a rough estimation of the position of a UE 114. In these embodiments, the coverage area of the n synchronization beams is partitioned into a plurality of zones each having a unique zone ID. The partitioning of zones is based on, for example, comparison of the RSRPs of the n overlapping synchronization beams. Referring to the example shown in FIG. 14 (wherein n=R=3) and note that the UE 114 always simultaneously receives n=R synchronization beams 302, the service area 310 may be partitioned into:
beam-center zones 402 in each of which the RSRP of one synchronization beam (such as the i-th synchronization beam (1≤i≤n)) is greater than that of any other synchronization beam by at least a predefined RSRP threshold th₁ (which is known to the UE 114), that is,

$${RSRP}_{i} > {RSRP}_{k} + t {h}_{1} \qquad ( 1 )$$

where k=1, 2, . . . , R, and k*i. In some embodiments, the RSRP threshold th₁=3 dB; and
   beam-overlapping zones 404 which are the zones that do not satisfy Formula (1) (that is, the zones between the beam-center zones 402).

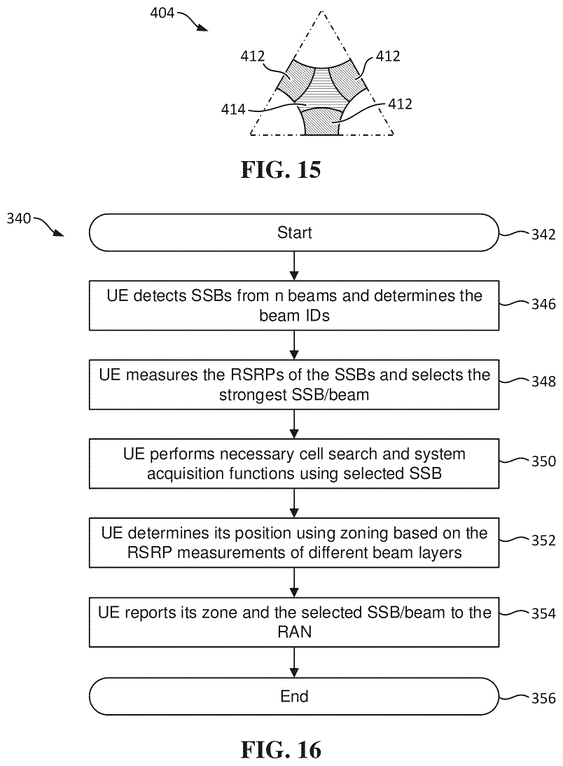

In some embodiments as shown in FIG. 15, the beam-overlapping zone 404 may be further partitioned into a plurality of zones (each assigned with a unique zone ID) including:
beam-unequally-overlapping zones 412, in each of which the sum of the RSRPs of two synchronization beams (such as the i-th and j-th synchronization beams (1≤i≤n, 1≤j≤n)) is greater than a weighted RSRP of any other synchronization beam by at least a predefined RSRP threshold th₂ (which is known to the UE 114), that is,

$$R S R {P}_{i} + RSR {P}_{j} > α R S R {P}_{k} + t {h}_{2} \qquad ( 2 )$$

where k=1, 2, . . . , R, and k*i, and a is a predefined weight known to the UE 114; in some embodiments, the weight α=2 and the RSRP threshold th₂=1 dB; and
   beam-equally-overlapping zone 414 which is the area of the beam-overlapping zone 404 that does not satisfy Formula (2) (that is, the subzone between the beam-unequally-overlapping subzones 412).

In some embodiments, the weight α and/or the the RSRP threshold th₂ may be obtained from the SIB.

FIG. 16 is a flowchart showing the steps of a cell search and system acquisition procedure 340 in these embodiments performed by the communication system 100 (in particular the RAN 104 and a UE 114) based on the above-described beam layout. In these embodiments, the UE 114 has the knowledge of the beam layout including, for example, the beam IDs and the IDs of the zones in the service area 310.

The cell search and system acquisition procedure 340 in these embodiments is similar to that shown in FIG. 12 except that, at step 352, the UE 114 determines its zone, wherein the determined zone meets the Formula (1). At step 354, the ID of the determined zone and information of the selected SSB are sent to the RAN 104 (for example, using a short feedback message of a few bits such as a Msg. 3 or Msg. A, respectively, during a four-step or two-step initial access procedure).

In some embodiments, to provide a more accurate estimate of the UE location, the UE 114 may feedback the difference of the RSRPs of the R−1 (R≥3) beams compared to the beam with the greatest RSRP. The received power difference may be quantized into 2^{b} levels such that a feedback message of the received power difference (comprising only b(R−1) bits) may be transmitted as a measurement report from the UE 114 to the RAN 104 in the connected mode. In some embodiments, the quantization levels (that is, the value of b) may be predefined. In some other embodiments, the quantization levels (or the value of b) may be configured by the RAN 104 based on the beam shape, beam layout, and/or the like, and be sent to the UE 114.

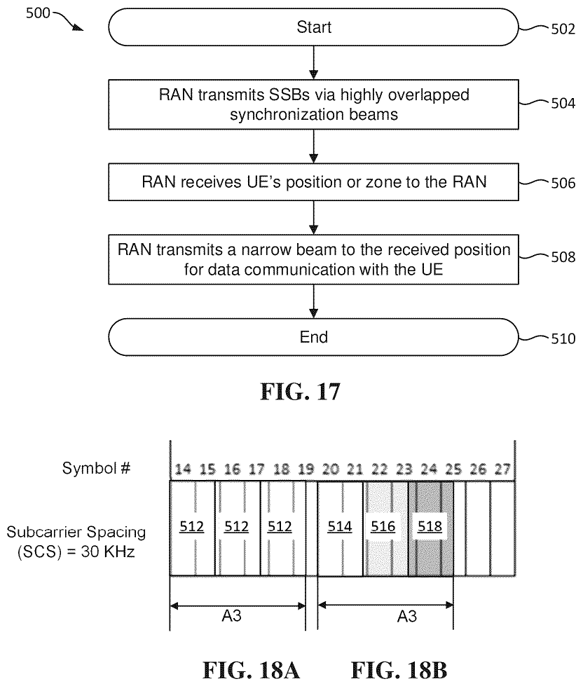

As those skilled in the art will appreciate, the RAN 104 may use the UE position or even a rough estimate thereof (such as the zone that the UE 114 is located) for any suitable purposes. For example, FIG. 17 is a flowchart showing the steps of an initial access and data communication procedure 500 performed by the communication system 100 (in particular the RAN 104 and a UE 114) based on the above-described beam layout, according to some embodiments of this disclosure. For ease of illustration, the initial access and data communication procedure 500 shown in FIG. 17 focuses on the cell search and system acquisition part of the initial access between the RAN 104 and the UE 114. Other functionalities are omitted.

When the procedure 500 starts (step 502), the RAN 104 (having one or more non-terrestrial TRPs 102B) transmits a plurality of synchronization beams towards the ground for transmitting SSBs from the RAN 104 to the UEs 114 in a service area 310 (step 504), wherein the synchronization beams are arranged in a highly overlapping beam-layout pattern as described above.

As described above the UE 114 detects n (n=R) synchronization beams 302 and reports its position or zone information to the RAN 102.

At step 506, the RAN 104 receives the position or zone information from the UE 114. Then, at step 508, the RAN 104 uses the position of the UE 114 to adaptively transmit a narrow signal-beam towards the position of the UE 114 for data transmission without the signaling overhead of sweeping multiple CSI-RSs for beam refinement. Herein, a narrow signal-beam refers to a signal beam with a beam size smaller or narrower than that of the synchronization beams 302. Generally, the beam size of the narrow signal-beam may be smaller or narrower than that of the conventional signal beams shown in FIG. 1.

The initial access and data communication procedure 500 is then completed (step 510).

As those skilled in the art will appreciate, when moving in the service area 310, the UE 114 may periodically report its location to the RAN 104 as UE-location updates, when the UE 114 moves from one zone to another zone, or when the UE 114 detects a different set of overlapping synchronization beams. In some embodiments, the RAN 104 may also adaptively refine or adjust the beam size and direction based on the UE-location updates reported from the UE 114. Moreover, based on its determined location, the UE 114 may (periodically or when needed) configure, reconfigure, or otherwise adjust certain parameters such as power, number of repetitions, bandwidth allocation, and/or the like, for subsequent uplink (UL) and/or downlink (DL) transmissions.

In some embodiments, the UE 114 may be configured or preconfigured with a PRACH-preamble repetition-pattern or repetition-format corresponding to a combination of detected SSBs. Then, the UE 114 may use a specific PRACH-preamble repetition-pattern based on the combination of the measurements of the overlapping synchronization beams 302, to provide the RAN 104 with an estimate of its position.

For example, in some embodiments, if the UE 114 detects an individual SSB with a strong RSRP (for example, a RSRP greater than a specific threshold thₐ), the UE 114 may form a PRACH signal by using a short PRACH format such as A1 as specified in the current NR standard with a small number of repetitions or copies of a PRACH sequence. On the other hand, if the greatest RSRP detected by a UE 114 is smaller than another specific threshold th_{b} (thₐ and th_{b} may or may not have the same value), the UE 114 may form a PRACH signal by using a large number of PRACH-sequence repetitions.

In some embodiments, the UE 114 may repeat a PRACH sequence or combine multiple PRACH sequences corresponding to the set of SSB(s) detected in a particular zone. For example, as shown in FIG. 18A, a UE 114 in a beam-center zone 402 may form a PRACH signal by using repetitions of a single PRACH sequence 512 corresponding to the synchronization beam of the beam-center zone 402. As shown in FIG. 18B, a UE 114 in a beam-overlapping zone 404 may form a PRACH signal by combining three PRACH sequences 514, 516, and 518 corresponding to the three overlapping synchronization beams. In the example shown in FIGS. 18A and 18B, the PRACH preamble format A3 according to NR is used.

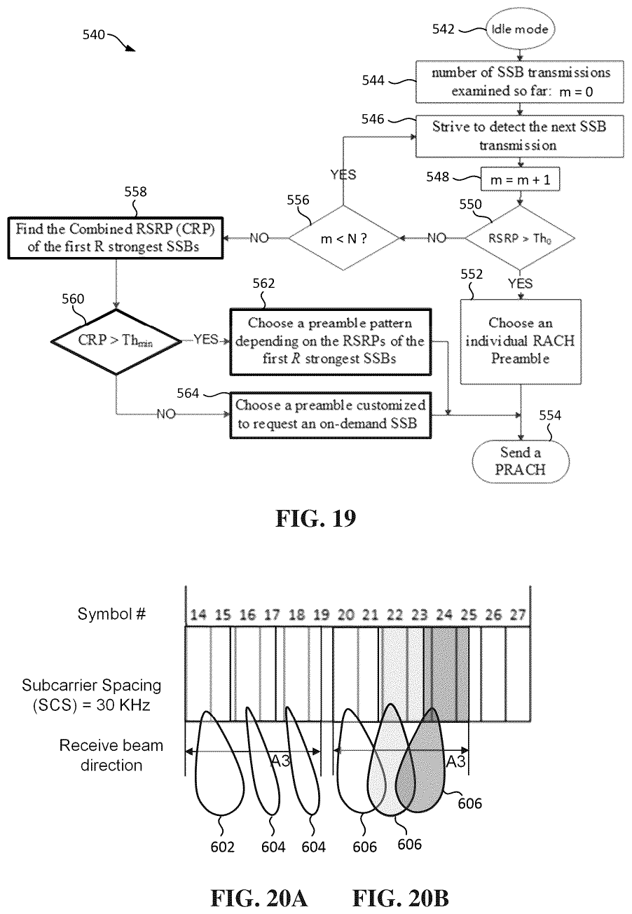

FIG. 19 is a flowchart showing an exemplary SSB detection and preamble transmission procedure 540 performed by a UE 114, according to some embodiments of this disclosure. The SSB detection and preamble transmission procedure 540 is similar to that used in NR except that the SSB detection and preamble transmission procedure 540 in this example comprises additional steps 558, 560, and 562 (illustrated in FIG. 19 using thick lines).

The SSB detection and preamble transmission procedure 540 may start when the UE 114 is at the idle mode or state (step 542). After start, the UE 114 initializes an SSB-transmission counter m to m=0 (step 544). Then, the UE 114 detects and examines (for example, retrieve the content of) an SSB transmission (that is, a synchronization beam) (step 546) and increase the counter m by one (step 548).

The UE 114 checks if the RSRP of the detected SSB transmission is greater than a threshold Th₀ (step 550). If the RSRP of the detected SSB transmission is greater than the threshold Th₀, the UE 114 chooses an individual random access channel (RACH) preamble (step 552) and sends a PRACH signal (step 554). The SSB detection and preamble transmission procedure 540 is then completed.

If at step 550, the RSRP of the detected SSB transmission is not greater than the threshold Th₀, the UE 114 checks if the counter m is less than n (step 556). If the counter m is less than N, the procedure 540 goes back to step 546 to detect and examine the next SSB transmission. If at step 556, the counter m is greater than or equal to N, the UE 114 then finds the combined RSRP (CRP) of the first R strongest SSBs (step 558).

At step 560, the UE 114 further checks if the CRP of the first R strongest SSBs is greater than a predefined CRP threshold Thₘᵢₙ (Thₘᵢₙ<Th₀). If the CRP of the first R strongest SSBs is greater than the predefined CRP threshold Thₘᵢₙ, the UE 114 then chooses a preamble pattern based on the RSRPs of the first R strongest SSBs (step 562) and sends a PRACH signal (step 554). The SSB detection and preamble transmission procedure 540 is then completed.

If at step 560, the CRP of the first R strongest SSBs is not greater than the predefined threshold Thₘᵢₙ, the UE 114 then chooses a preamble customized to request an on-demand SSB (that is, an on-demand synchronization beam or SSB directed to the location of the UE 114) and sends a PRACH signal (step 554). The SSB detection and preamble transmission procedure 540 is then completed.

Thus, the UE behavior is similar to that in in NR if the UE detects a strong SSB with an RSRP greater than Th₀; otherwise, the UE behavior is different to that in in NR wherein the UE performs the SSB detection and preamble transmission procedure 540 to choose a preamble pattern based whether there exist one or more SSBs with a CRP thereof greater than the predefined threshold Thₘᵢₙ.

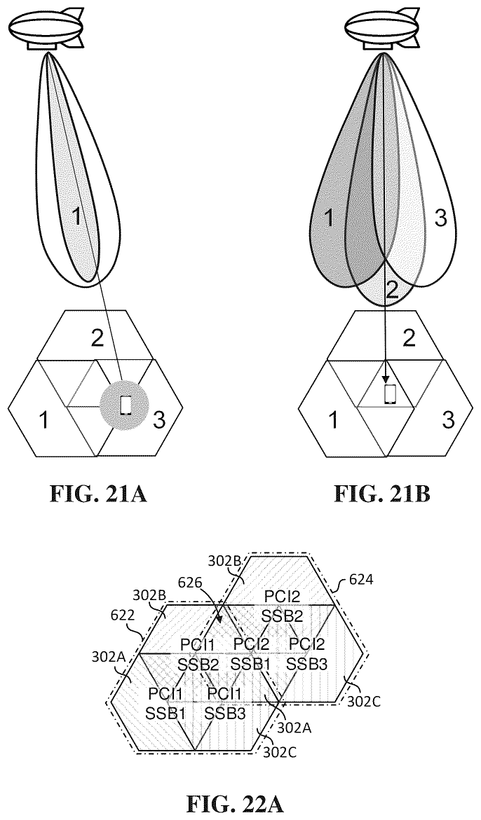

At the RAN 104 side, a correspondence between preamble resources (that is, repetitions) and receive beams (which are beams transmitted from the UE 114 and received by the RAN 104) may be used to effectively detect the preamble signals. Particularly, the RAN 104 may detect the first repetition of each sequence using overlapping beams of a wide width (that is, overlapping beams of a large size), while the subsequent repetitions of the same sequence are to be detected by more focused beams (that is, beams of a narrow width or a small size). Thus, as shown in FIGS. 20A and 21A, the first repetition of a sequence transmitted by a UE 114 located near a beam center or in a beam-center zone is processed through a wide beam 602, while the subsequent repetitions are received using narrow beams 604, thereby enhancing the achievable gain. As shown in FIGS. 20B and 21B, if the UE 114 is not near a beam center (or, the UE 114 is in a beam-overlapping zone), the three sequences are received over three overlapping, wide-width beams 606, wherein the combination of the signals received using the overlapping, wide-width beams 606 may result in high gains for the UE 114 (that is, effectively achieving a similar result of using a narrow beam).

Thus, the communication system 100 in these embodiments enhances the link budget for PRACH transmission and/or provides a rough estimate of the UE location with respect to the beam layout. Moreover, the communication system 100 in these embodiments enables the RAN 104 or a non-terrestrial TRP 102B thereof to obtain a more accurate estimate of the location of a UE 114 based on the uplink measurements (such as measurements of PRACH (which is transmitted in uplink direction) conducted by the RAN 104). Particularly, the RSRP of PRACH sequence repetitions measured using different receive overlapping beams can be used to find an estimate of the user location based on triangulation. An estimate of the user location then may be used to deploy narrower beams for subsequent transmissions. Thus, in these embodiments, the UE 114 does not need to explicitly feedback the downlink measurements for positioning. Rather, the UE 114 may select an appropriate PRACH based on the downlink measurements, and then the RAN 104 may locate the UE position based on PRACH measurements.

In some embodiments, the UE 114 of the communication system 100 may easily switch from one cell (or a non-terrestrial TRP 102B) to another cell (or another non-terrestrial TRP). In these embodiments, each cell comprises R highly overlapped synchronization beams of R beam layers (such as each LCP 304). The cells are indexed and each cell is associated with a PCI. The synchronization beams 302 of the same cell are used to transmit SSBs carrying the same PCI.

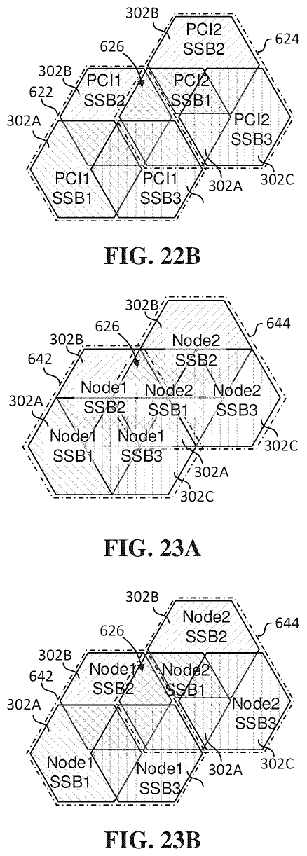

The synchronization beams 302 of the same cell are used to transmit SSBs carrying the same PCI. For example, FIG. 22A shows two cells 622 and 624 each comprising three overlapping synchronization beams 302A, 302B, and 302C. FIG. 22B shows the same two cells 622 and 624 with gaps between the synchronization beams 302A, 302B, and 302C for better illustration of the coverage areas of different beams 302.

As can be seen, each pair of adjacent cells (such as a first cell 622 and a second cell 624) have a transition region 626 wherein at least one or more synchronization beams of the first cell 622 overlap with one or more synchronization beams of the second cell 624, which ensures smooth cell-switching from the first cell 622 to the second cell 624 as the measurements of adjacent cells 622 and 624 are available in advance (that is, before a UE 114 in the first cell 622 reaches the boundary of the first cell 622 and needs to switch to the second cell 624).

FIG. 23A shows two adjacent coverage areas 642 and 644 each being covered by three overlapping synchronization beams 302A, 302B, and 302C transmitted from a respective non-terrestrial TRP (not shown). FIG. 23B shows the same two coverage areas 642 and 644 with gaps between the synchronization beams 302A, 302B, and 302C for better illustration of the coverage areas of different beams 302. Similar to the example shown in FIGS. 22A and 22B, a UE 114 may smoothly TRP-switching with the measurements of adjacent coverage areas 642 and 644 are available in advance (that is, before a UE 114 in the first coverage area 642 reaches the boundary of the first coverage area 642 and needs to switch to the second coverage area 644).

With above description, those skilled in the art will understand that the communication system 100 disclosed herein provides various technical features and benefits such as:
The association of SSBs with different beam IDs alleviates the cell-edge issue, and enhances the SSB link budget by exploiting an overlapping beam layout for SSB transmission, which achieves a rather uniform RSRP across the coverage region.
The configurations of the above-described beam layout enable the UE 114 to locate its position with respect to the beam layout. Example of such configurations include
   the number of beam layers and/or zones;
   the parameters to determine the UE position or UE zone (such as the RSRP thresholds th₁, th₂, the CRP threshold Thₘᵢₙ, the weight α, and the like); and
   the mapping of the beams to their beam IDs.

Such configurations provide simple methods to partition the service area 310 and to locate the UE position using the synchronization beams 302.
The methods of locating the user position and signaling the related beam IDs enables adaptive beam deployment and/or (re-)configuration for data transmission with:
   reduced overhead of reference signal transmission for beam refinement;
   reduced inter-beam interference for data channel;
   enhanced resource utilization and capacity; and
   enhanced non-terrestrial TRP energy efficiency.

The above technical features generally solve the problem of the cell-edge issue, and provide a simple method for UE positioning which in turn supports deployment of narrow beams for data-transmission at a low overhead.

The communication system 100 disclosed herein also provides additional technical features and benefits such as:
The methods of (pre-)configuring the UE 114 with preamble repetition patterns/formats corresponding to combinations of detected SSBs including:
   determining whether the UE 114 is located near the beam center or in the middle of a number of nearby beams;
   using a preamble repetition pattern based on the detected SSBs; and
   using appropriate receive beams for detecting preamble sequences.

Such methods enhance the link budget for SSB and PRACH signals transmission, and provide an accurate estimate of the UE location based on the uplink measurements.
Reporting the measurements of adjacent cells which have an overlapping beam with the currently serving cell that the UE 114 is therewith, which facilitates beam/cell switching as the measurements for adjacent cells may be available in advance before the UE 114 moves to the edge of the currently serving cell.

In above embodiments, the communication system 100 is a system combining terrestrial communication networks with non-terrestrial communication networks, such as combining cellular networks with satellite communication networks. In some embodiments, the terrestrial communication networks may comprise, or alternatively be, other radio access networks such as WI-FI® networks (WI-FI is a registered trademark of Wi-Fi Alliance, Austin, TX, USA).

In above embodiments, the beam layout configuration of and cell search and system acquisition methods are described with respect to non-terrestrial TRPs 102B. In some embodiments, the beam layout configuration of and cell search and system acquisition methods disclosed herein may be used by terrestrial TRPs 102A. In some embodiments, the beam layout configuration of and cell search and system acquisition methods disclosed herein may be used in any suitable communication systems where the coverage is limited and a low overhead is required for reference signal transmission and beam refinement.

In above embodiments, the term “configured” or “pre-configured” includes configuration as specified in the standard (that is, no signaling is needed), configured via different layer signaling such as an RRC signaling, a medium access control layer signaling, a physical layer signaling, or any combination thereof. The RRC signaling may be a broadcast signaling such as master information block (MIB) or SIB, a dedicated RRC signaling (a UE-specific RRC signaling), or a group-based RRC signaling. Similarly the MAC layer signaling and the physical layer signaling may be broadcast signaling, group signaling or dedicated signaling.

### C. Acronym Key

CSI-RS: Channel State Information Reference Signal
HAPS: High Altitude Platform Stations
NTN: Non-Terrestrial Network
NTN: Non-Terrestrial Network
PSS: Primary Synchronization Signal
QCL: Quasi Co-Located
RMSI: Remaining Minimum System Information
RS: Reference Signal
RSRP: Reference Signal Received Power
SSB: Synchronization Signal Block
SSS: Secondary Synchronization Signal
UE: User Equipment

### D. Definitions of Some Technical Terms

Channel Access Preamble: A specific sequence selected from a set of predefined or preconfigured sequences and sent by a user equipment (UE) to initiate access to the wireless network.

Four-step random/channel access procedure: A procedure to initiate access to a new cell/beam in the wireless network. In the first step, a UE transmits a preamble to the network (also denoted “Msg. 1” over PRACH). In the second step, the network sends a random access response (RAR; also denoted “Msg. 2” over PDSCH scheduled by PDCCH) to the UE. In the third step, the UE sends a radio resource control (RRC) connection request (also denoted a “Msg. 3” over PUSCH). In the fourth step, the network confirms the establishment of a connection with the UE by transmitting a contention resolution (also denoted a “Msg. 4” over PDSCH scheduled by PDCCH) to the UE.

Two-step random/channel access procedure: A procedure to initiate access to a new cell/beam in the wireless network. In the first step, a UE transmits a preamble to the network over PRACH along with a radio resource control (RRC) connection request over PUSCH (also denoted as “Msg. A”). In the second step, the network sends a random access response (RAR) and confirms the establishment of a connection with the UE by transmitting a contention resolution to the UE (also denoted as “Msg. B”).

Msg. A: The first message transmitted during a two-step random access procedure to request access to the network. It comprises a preamble and a payload (carrying the information that is otherwise transmitted via Msg. 3 in the four-step procedure).

Although embodiments have been described above with reference to the accompanying drawings, those of skill in the art will appreciate that variations and modifications may be made without departing from the scope thereof as defined by the appended claims.

1. A method comprising:
receiving a plurality of synchronization signal and physical broadcast channel (PBCH) blocks (SSBs) of a plurality of beams of a plurality of different beam layers, wherein each SSB of the plurality of SSBs is associated with a respective beam of the plurality of beams, and each beam of the plurality of beams is associated with a respective beam layer of the plurality of different beam layers;
determining reference-signal received powers (RSRPs) of the plurality of SSBs; and
selecting one or more SSBs of the plurality of SSBs based on the RSRPs for performing an initial-access procedure to a serving cell.

2. The method of claim 1, wherein the receiving the plurality of SSBs comprises:
determining an association of the plurality of SSBs and the plurality of different beam layers based on one or more characteristics of the plurality of SSBs.

3. The method of claim 2, wherein the one or more characteristics of the plurality of SSBs are one or more of:
one or more characteristics of a frequency domain,
one or more characteristics of a time domain, one or more characteristics of a code domain, one or more characteristics of a space domain, and
content of the plurality of SSBs.

4. The method of claim 3, wherein the content of the plurality of SSBs comprises identifiers (IDs) of the plurality of different beam layers.

5. The method of claim 1, wherein the selecting the one or more SSBs of the plurality of SSBs based on the RSRPs comprises:
selecting a first SSB associated with a first beam layer of the plurality of different beam layers, the first SSB having a greatest RSRP among first SSBs associated with the first beam layer; or
selecting first one or more SSBs of the plurality of SSBs associated with the first beam layer, first RSRPs of the first one or more SSBs are greater than a first RSRP threshold.

6. The method of claim 1, further comprising:
determining and reporting position information based on the plurality of SSBs and the RSRPs.

7. The method of claim 6, wherein the determining and reporting the position information comprises:
reporting IDs of one or more beam layers corresponding to the one or more SSBs.

8. The method of claim 6, wherein the determining and reporting the position information comprises:
determining relative distances to the plurality of different beam layers based on the RSRPs;
determining a relative position with respect to the plurality of different beam layers using triangulation based on the relative distances; and
reporting at least one of the relative position or the relative distances.

9. The method of claim 6, wherein the determining and reporting the position information comprises:
determining a zone based on the RSRPs; and
reporting the zone.

10. The method of claim 9, wherein the determining the zone comprises:
determining a beam-center zone of a beam of the plurality of beams based on that an RSRP of the beam is greater than that of any other one of the plurality of beams by at least a second RSRP threshold; or
determining a beam-overlapping zone of the plurality of beams otherwise.

11. The method of claim 9, wherein said reporting the zone comprises:
sending a physical random access channel (PRACH) signal corresponding to the zone.

12. The method of claim 11,
wherein the PRACH signal comprises three or more PRACH sequences; and
wherein the three or more PRACH sequences comprises three or more repetitions of a same PRACH sequence based on that the determined zone is a beam-center zone; or wherein the three or more PRACH sequences comprises three or more different PRACH sequences based on that the determined zone is a beam-overlapping zone.

13. A method comprising:
transmitting synchronization signal and physical broadcast channel (PBCH) blocks (SSBs) via a plurality of synchronization beams towards an area, the plurality of synchronization beams associated with three or more beam layers;
wherein each beam layer of the three or more beam layers comprises one or more synchronization beams of the plurality of synchronization beams;
wherein coverage areas of the three or more beam layers are at least partially overlapping;
wherein any two synchronization beams of the three or more beam layers cover different coverage areas; and
wherein the one or more synchronization beams of each beam layer are associated with respective beam IDs.

14. The method of claim 13, wherein the three or more beam layers are associated with different frequencies.

15. The method of claim 13, wherein the plurality of synchronization beams are identifiable via one or more characteristics of the SSBs.

16. The method of claim 15, wherein the one or more characteristics of the SSBs are one or more of:
one or more characteristics of a frequency domain,
one or more characteristics of a time domain,
one or more characteristics of a code domain,
one or more characteristics of a space domain, or
content of the SSBs.

17. The method of claim 13, further comprising:
receiving position information from a user equipment (UE) in the area; and
transmitting a data beam towards a direction based on the position information for data communication with the UE.

18. The method of claim 17, wherein the position information comprises the respective beam IDs of one or more of the plurality of synchronization beams associated with different beam layers, a position of the UE, or an ID of a zone that the UE is located therein.

19. The method of claim 18, wherein the transmitting the data beam towards the direction based on the position information comprises:
transmitting the data beam towards the position of the UE or the zone that the UE is located therein,
wherein the data beam has a size smaller than that of each of the plurality of synchronization beams.

20. One or more non-transitory computer-readable storage devices comprising computer-executable instructions, wherein the computer-executable instructions, when executed, cause one or more processing units to perform:
transmitting synchronization signal and physical broadcast channel (PBCH) blocks (SSBs) via a plurality of synchronization beams towards an area, the plurality of synchronization beams associated with three or more beam layers;
wherein each beam layer of the three or more beam layers comprises one or more synchronization beams of the plurality of synchronization beams;
wherein coverage areas of the three or more beam layers are at least partially overlapping;
wherein any two synchronization beams of the three or more beam layers cover different coverage areas; and
wherein the one or more synchronization beams of each beam layer are associated with respective beam ID.
